(19) United States
(12) Patent Application Publication
(10) Pub. No.: US 2002/0064757 A1
(43) Pub. Date: May 30, 2002

(54) Visual identification coding of endodontic files

(76) Inventor: Leon A. Cerniway, Chesapeake, VA (US)

Correspondence Address: ANDREW M. HILL, 2101 CRYSTAL PLAZA ARC., PMB 160, ARLINGTON, VA, 22202, US

(21) Appl. No.: 10/056,076

(22) Filed: Jan. 28, 2002

Related U.S. Application Data
(60) Provisional application No. 60/180,961, filed on Feb. 8, 2000.

(51) Int. Cl. A61C 5/02; A61C 19/04

(52) U.S. Cl. 433/102; 433/224; 433/72

(57) ABSTRACT

Method and apparatus for visually grouping and organizing endodontic files for expeditious selection and use during a root canal procedure. The method calls for marking reference points for each root canal on the crown of the tooth to be treated, using distinguishing colors or other visually perceptible characteristics. The reference points so color coded correspond to colors marked on a file holder, so that a dental practitioner can quickly and accurately select a file from an array of prepared files, wherein the selected file is appropriate for a tooth being addressed at any one point during the procedure. Files associated with any one root canal are held in a portion of the file holder bearing a distinctive color, and thus can be readily identified as being associated with one another. Marking the tooth with a similar color enables the several files prepared for any one root canal to be quickly associated with the correct root canal. The preferred file holder is a jig or gauge configured to provide an additional function of setting exposed file lengths for each file to be used in each canal. The gauge has a plurality of stepped members slidably mounted thereon in a position enabling the steps to engage files held in the holder. Rubber stops placed on the files can be appropriately positioned along their respective files for a root canal procedure.

### REFERENCE TO RELATED APPLICATION

This application claims priority benefit of Provisional Patent Application Serial No. 60/180,961, filed Feb. 8, 2000 and of Utility Patent Application Serial No. 09/778,815, filed Feb. 8, 2001.

### BACKGROUND OF THE INVENTION

1. Field of the Invention

The present invention relates to geometric dental tools and more particularly to apparatus and method of visually correlating prepared dental instruments with associated root canals being treated in a root canal procedure, e.g., by color coding of a holder of the tools coordinated with marks made on the operative tooth for each distinct canal of that tooth.

2. Description of the Prior Art

When the nerve of a tooth dies or other injury occurs to pulp tissue of a tooth, potentially necrotic and infected tissue must be removed. The canal containing pulp tissue is enlarged and sterilized, and then filled with an inert material. Removal of pulp tissue and enlargement of the canal are performed by drilling a hole through the top of the tooth, then reaming out the canal of each root of the tooth. Reaming of each canal is performed usually in several progressive steps, starting with the smallest file diameter and progressing to the largest. Each of the files must be set to the radiographic length of that canal. For example, a single root canal procedure may require four or more files of varying diameter for each canal of the tooth presented. The progression culminates in a single file of minimum diameter utilized at the apex of the root.

The procedure requires establishment of a fixed point of reference, called the datum point, on the tooth itself. Each canal to be treated requires a datum point that is within the diameter of the stop which encircles each file. The distance from the datum point to the tip end, or apex of the root, is established. This is referred to as the “radiographic length”, usually obtained from X-rays. From this information, the dimensions of progressive file lengths are determined according to the particular surgical technique chosen by the clinical practitioner. Because of the number of files of differing diameter and lengths required, it is not uncommon for a treatment of a single, multi-canal tooth to include more than sixty file length settings.

The several sets of endodontic files for each succeeding increment of file length are prepared with great precision to correspond to the length of each section of each root canal. Generally torroidal or disc-like resilient stops are placed over each endodontic file which will be utilized in the procedure. These stops limit maximal penetration of the file into the canal. Precision of placement of a stop on its associated file is of great importance in limiting the exposed portion of the files. The precision required and the large number of settings present a significant risk of error, and multiply time required to perform the procedure.

Contemporary practice in root canal procedures is to record pertinent data relating to the procedure on a form which becomes part of the permanent record. However, due to anatomical variations and other conditions of the procedure, sequence in which instruments are used may vary from the sequence in which instruments are listed on the form. This causes the practitioner to devote unnecessary time and attention to assure that appropriate file lengths be selected for each root canal. This is distracting, potentially introduces error to the procedure, and increases the amount of time required to perform a root canal procedure. The prior art has not suggested a method of and apparatus for visually relating the radiographic length of a canal and its associated datum point on the tooth to the endodontic gauge.

### SUMMARY OF THE INVENTION

The present invention improves on conventional apparatus and procedures used for root canal procedures. Notably, both the datum points placed on the teeth and the apparatus used to hold prepared endodontic files are color coded to expedite selection and use of the endodontic files during the procedure. This is accomplished by correlating the color of the apparatus containing files for a given tooth canal to the color of the datum points for that canal marked on the operative tooth.

The apparatus for holding prepared endodontic files can be any device provided with slots or other structure for receiving or holding files, the device preferably having structure for segregating groups of files by association with one root canal. It is preferred to employ an endodontic gauge of a type more particularly set forth in the above referenced prior application, which is hereby incorporated by reference. If improved according to the principals of the present invention, the endodontic gauge presented therein provides a single apparatus which enables both setting of exposed length of entire sets of files, and also color coded identification which enables expeditious selection of files and reduces risk of using a file set up for one canal on a different canal.

The apparatus is provided with predetermined coloring or other visual characteristics to enable the user to sense organization of files grouped by association with a particular root canal. Reference marks or datum points of identical or substantially similar coloring are placed on each tooth for each group of files associated with one root canal. When it is time to ream a root canal, selection of appropriate files is assured by selecting a file from that portion of the apparatus holding prepared files which bears the same coloring as the datum point placed on the tooth for the corresponding canal. Time and concentration expended on assuring selection of proper files and their use in the proper associated canal are minimized. Chances of introducing error to the procedure and possibly damaging a root are correspondingly reduced.

Accordingly, it is an object of the invention to organize visually sets of endodontic tools with respect to their associated canals of the operative tooth.

It is a further object of the invention to utilize color coding to visually group sets of files and to associate said files with the appropriate canal for which they are set up.

It is an object of the invention to provide improved elements and arrangements thereof in an apparatus for the purposes described which is inexpensive, dependable and fully effective in accomplishing its intended purposes.

These and other objects of the present invention will become readily apparent upon further review of the following specification and drawings.

### BRIEF DESCRIPTION OF THE DRAWINGS

Various other objects, features, and attendant advantages of the present invention will become more fully appreciated as the same becomes better understood when considered in conjunction with the accompanying drawings, in which like reference characters designate the same or similar parts throughout the several views, and wherein:

FIG. 1 is a perspective view of an embodiment of the apparatus of the present invention, which view omits elements of color coding of the present invention.

FIG. 2 is an environmental, top plan view of the device of FIG. 1, again omitting elements of color coding.

FIG. 3 is a diagrammatic plan view of slides generally corresponding to four such slides seen along the center of FIG. 1, again omitting elements of color coding.

FIG. 4 is an enlarged end cross sectional detail view taken along line 4-4 of FIG. 2.

FIG. 5 an enlarged top plan detail view of one of the slides depicted along the center of FIG. 1, again omitting elements of color coding.

FIG. 6 is an enlarged environmental side elevational detail view of the slide of FIG. 5, showing an endodontic ruler in place for making measurements.

FIG. 7 is a diagrammatic, perspective view of a tooth bearing colored reference marks or datum points made according to the invention.

### DETAILED DESCRIPTION OF THE PREFERRED EMBODIMENTS

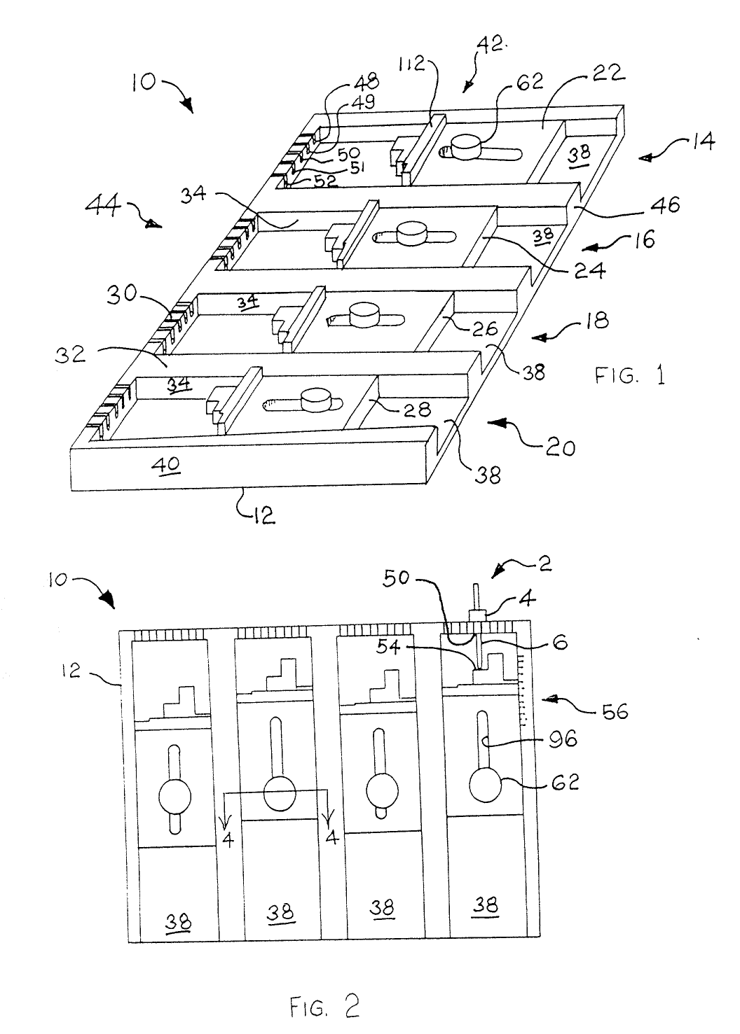

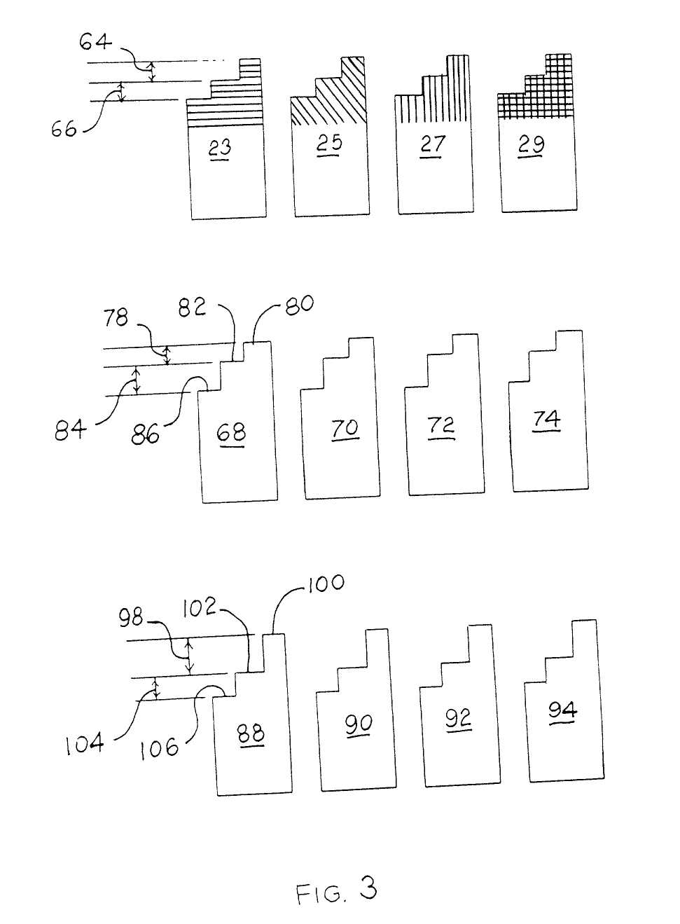

FIG. 1 of the drawings shows a preferred form of a device for setting and holding files. This device is a gauge 10 which provides an additional function of selectively positioning stops along the shaft of an endodontic file (see FIG. 2). It should be understood from the outset that the precise nature of any particular file holding device employed is not critical per se to the invention, apart from its ability to set the lengths, hold, and present files to view. The invention presented herein resides in color coding to enable visual organization of endodontic files for expeditious selection during a root canal procedure. Gauge 10 is presented only as a preferred embodiment of a file holder, and will be described to a level of detail affording the reader appreciation of its additional function in setting effective file lengths.

### 1. Description of the Preferred File Holder

Gauge 10 comprises a base 12 in which are formed four coplanar, parallel tracks 14, 16, 18, 20. A plurality of slidable members or slides 22, 24, 26, 28 which are dimensioned and configured to be slidably disposed within tracks 14, 16, 18, and 20 are shown installed. Base 12 has a file retainer in the form of retaining barrier 30 spanning tracks 14, 16, 18, 20. Base 12 has an upper surface 32 common to retaining barrier 30 and to side walls 34 of tracks 14, 16, 18, 20. The function of barrier 30 will be described hereinafter.

The bottom of base 12, as depicted in FIG. 1, is formed by a floor 38 (see also FIG. 2) which extends continuously from side 40 to respective opposing side 42, and from proximal side 44 to respective opposing distal side 46. Designation of side 44 as proximal and of side 46 as distal are merely for semantic convenience. The proximal side is that into which files are inserted into retaining barrier 30. The term will also be applied for convenience to tracks 14, 16, 18, 20, and refers to that end of tracks 14, 16, 18, 20 proximate retaining barrier 30.

Apart from being a structural member, floor 38 closes each track 14, 16, 18, or 20 at the bottom thereof. This both assists in guiding and constraining slides 22, 24, 26, 28 to move only longitudinally within associated tracks 14, 16, 18, 20 which are dimensioned and configured to accomplish this, and also obstructs contaminants (not shown) from impinging from below upon endodontic files (see FIG. 2) held within base 12.

The use of gauge 10 is illustrated in FIG. 2. An endodontic file 2 is shown held in base 12. File 2 is passed through one of five openings 48, 49, 50, 51, 52 formed in retaining barrier 30 at track 14. Openings 48, 49, 50, 51, 52 are preferably slots which are open from above so that a file may be laid in each one prior to sliding the file into contact with its associated slide. Openings 48, 49, 50, 51, 52 are each dimensioned and configured to receive therein one endodontic file such that all endodontic files (only one file 2 is shown) inserted within openings 48, 49, 50, 51, 52 are in coplanar relation to one another. A rubbery, generally torroidal or disc-like stop 4 has been placed in encircling relation to the shaft of file 2 prior to insertion of file 2 into opening 50. File 2 has been passed through opening 50 until its distal end contacts a step 54 formed on slide 22.

Slide 22 has a stepped surface facing retaining barrier 30 at its proximal end (that being the end facing retaining barrier 30) and an opposed distal end. The stepped surface is disposed to occupy track 14, and to move selectively towards and away from the proximal end of track 14 when slide 22 traverses track 14. The stepped surface has five flat steps 54, 55, 57, 58, 60 (see FIG. 5). Each step 54, 55, 57, 58, or 60 is spaced apart from the distal end of track 14 by a distance interval different from that by which every other step 54, 55, 57, 58, or 60 is spaced apart from the distal end of track 14.

In the depiction of FIG. 2, slide 22 has been moved to a selected position within track 14 such that exposed length 6 of file 2 corresponds to a measurement derived from the radiographic length, which is established by X-ray or equivalent images (not shown). Positioning of slide 22 is precisely accomplished by moving slide 22 to appropriate registry with measurement indicia 56 disposed upon upper surface 32 of base 12 proximate and along track 14. Indicia 56 enables visual confirmation of exposed length of each endodontic file retained within retaining barrier 30. A similar goal is achieved by the use of an endodontic ruler, as explained hereinafter. Slide 22 bears a suitable index or reference mark (not shown) for registry with indicia 56. Stop 4 is prevented from moving in tandem with file 2 as file 2 is pushed through opening 50, stop 4 thereby moving to an adjusted position along the shaft of file 2 as facilitated by retaining barrier 30. Alternatively stated, retaining barrier 30 causes stop 4 which has been placed in encircling relation on the shaft of endodontic file 2 to slide along the shaft when the shaft is advanced through opening 50. When exposed length 6 of file 2 touches step 54, position of stop 4 on file 2 has been adjusted to the desired distance. File 2 is now ready for use.

Other files (not shown), also for use on the same root canal, will be similarly adjusted, using other openings 48, 49, 51, or 52, of retaining barrier 30, and other steps 55, 57, 58, or 60 of slide 22. Another file (not shown) is passed through an opening 48, 49, 51, or 52 until it contacts its associated step 55, 57, 58, or 60 of slide 22. The length of the exposed portion of file 2 and other files adjusted using slide 22 is predetermined once slide 22 has been adjusted to the appropriate position in accordance with the radiographic length of the canal. The procedure for positioning the stops of the subsequent files is the same as that employed for file 2. Files associated with any one slide may obviously be adjusted in any desired order.

Each track 14, 16, 18, or 20 preferably has height, width of magnitude greater than that of the height, and length of magnitude greater than that of the width. This relationship causes gauge 10 to be generally planar, apart from nominal and structural thickness of its components, so that all of the files are held in an accessible, visible parallel, coplanar array.

It will be appreciated that because track 14 and slide 22 are generally similar in function to respective tracks 16, 18, and 20 and slides 24, 26, and 28, description of track 14 and slide 22 will therefore be understood to apply as well to tracks 16, 18, and 20 and to slides 24, 26, and 28. The only significant difference is in dimensions and proportions among the various slides, as will be further explained hereinafter. In a similar vein, retaining barrier 30 has five openings (not indicated by individual reference numerals) for each one of tracks 16, 18, 20, as well as for track 14.

In operation, each track 14, 16, 18, or 20 is assigned to a canal in the tooth to be treated. Each track 14, 16, 18, or 20 can, with a single adjustment to its associated slide 22, 24, 26, or 28, therefore set up to five operational file lengths as dictated by the chosen endodontic technique. Each operational length is a predetermined variance from the radiographic length of the individual canal.

All tracks 14, 16, 18, 20 face upwardly when base 12 is oriented horizontally, with floor 38 facing downwardly. Therefore, all five file lengths established by slides 22, 24, 26, 28 after adjustment are exposed to view from above.

Once positioned as desired, and prior to inserting files into openings 48, 49, 50, 51, 52, slide 22 is secured within base 12 by turning a setscrew which preferably is a thumbscrew 62. It will be understood that slides 24, 26, 28 each have an equivalent thumbscrew.

Differences among the dimensions and proportions of the various slides will now be described, with reference to FIG. 3. FIG. 3 illustrates a second embodiment of a gauge wherein slides 23, 25, 27, 29 each have other than five steps. The number of steps arbitrarily selected for purpose of illustration is three. Variations among the slides are selected to conform to teachings of different clinical techniques for root canal procedures. FIG. 3 is diagrammatic in that it shows only the profile or silhouette of each slide, omitting other features described elsewhere herein. It will be understood that the various slides of FIG. 3 include necessary features required for operability but which are deleted from FIG. 3.

It will be seen that distance intervals 64, 66 by which steps of slides 23, 25, 27, 29 of a first group of slides are spaced apart from one another are constant or similar distance intervals. This is not the only possible relationship. A second group comprising slides 68, 70, 72, 74 has a distance interval 78 separating a step 80 for establishing the shortest exposed file length from an intermediate step 82 which is smaller than a distance interval 84 separating intermediate step 82 from step 86. It will be understood that although steps 80, 82, 86 are shown only on slide 68, slide 68 and steps 80, 82, 86 are representative of slides 70, 72, 74.

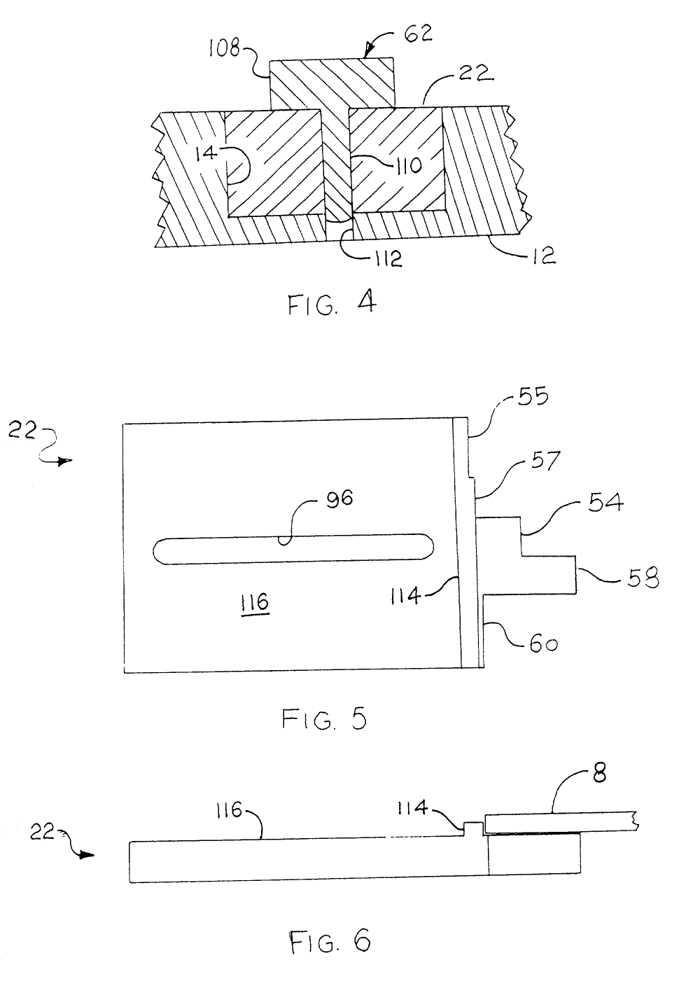

FIG. 4 illustrates one method of securement of slide 22 within track 14. Thumbscrew 62 is seen to comprise an enlarged head 108 which enables grasping by finger and a threaded shank 110 which threaded shank 110 engages a threaded hole 112 formed in slide 22. Shank 110 passes through a slot 96 (see FIG. 5) formed in slide 22. Thumbscrew 62 is turned to thread to and engage hole 112. Continuing to turn thumbscrew 62 will immobilize slide 22 within its associated track 14.

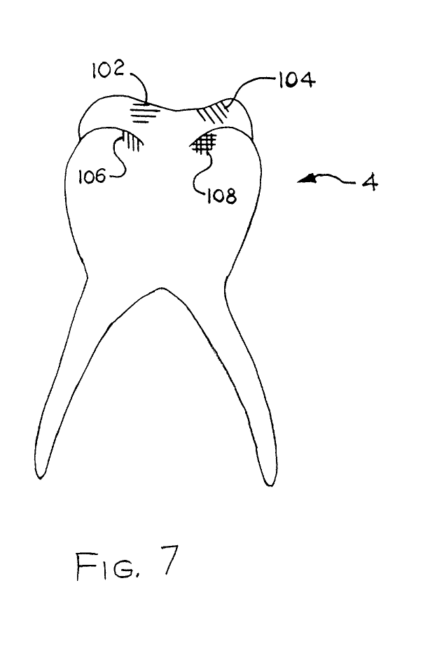

In FIGS. 5 and 6, it will be seen that slide 22 has a ridge or flange 114 which projects upwardly above upper surface 116 of slide 122. Flange 114 serves as a stop against which an endodontic ruler 8 may be placed for making measurements in adjusting position of slide 22 within base 12 (see FIG. 1). This is a preferred embodiment which renders indicia 56 (see FIG. 2) unnecessary, although both may be provided if desired. It will be seen from examining FIG. 5 that step 55 is recessed behind the forward surface of flange 114. Step 57 is coincident or coplanar with the forward surface of flange 114. Steps 54, 58, 60 are located forwardly of the forward surface of flange 114. While step 60 is shown lower than step 58, steps 55, 57, 54, 58, and 60 are considered to be generally arranged in ascending order with respect to distance to the retaining barrier. The order shown generally corresponds to the order required in the treatment procedure, thus facilitating ease of use, although other orders could be employed.

### 2. Color Coding

Files (e.g., file 2 of FIG. 2) are correlated for use with each root canal by any suitable visual marking technique applied to a file holder such as gauge 10. It is contemplated that the most practical form of marking is to place coloring permanently on the holder holding prepared files until use, and to place similar coloring on a tooth as reference marks or datum points. In the preferred invention, file holding apparatus comprises gauge 10, which is modified to bear color coding at any suitable location thereon.

FIG. 3 shows one way in which the apparatus may be color coded. As seen at the top of FIG. 3, four slides 23, 25, 27, 29 are each provided with pigment or other coloring of hues differing from those of other slides 23, 25, 27, 29. In the example of FIG. 3, slide 23 is colored at the upper end thereof with a blue hue, slide 25 bears a green hue, slide 27 bears a red hue, and slide 29 bears a black hue. Each slide therefore has its own distinctive coloring. All files the lengths of which are set on retaining barrier 30 which are longitudinally aligned with any one particular slide (e.g., 23, 25, 27, or 29) will be readily discerned as being associated with that one slide, and that the particular slide is associated with a particular root canal in the following way.

FIG. 7 shows a tooth 4 bearing reference marks or datum points 102, 104, 106, and 108. Each reference mark 102, 104, 106, or 108 is established by the dental practitioner to reflect a suitable location for determining and defining radiographical length of each root canal of the operative tooth. Reference marks 102, 104, 106, 108 are distinctively made to exhibit hues or colors corresponding to those appearing on color coded slides (e.g., slides 23, 25, 27, 29) such that a correlation is established between each particular root canal, a particular slide, and a group of files prepared by use of the associated slide. It is then an easy matter once the procedure is commenced to set the predetermined exposed length of every file in a set that is to be used in a given root canal, by using the slide that bears the color corresponding to the color of the reference mark of the root canal being addressed at that stage of the procedure.

As mentioned previously, certain portions of gauge 10 are permanently colored. Reference marks 102, 104, 106, 108 are each applied with a different color from that used to mark all others as part of the root canal procedure. This may be done with any suitable marking apparatus, including commercially available marking pens (not shown). Hues of the reference marks need not exactly match those of gauge 10, provided that they are sufficiently similar to establish immediate visual correlation when viewed by the dental practitioner.

It is contemplated that color is the best form of visual marking by which differentiation of groups of files may be made. However, other forms of visual or even tactile markings may be utilized instead of or in addition to color. Surfaces of gauge 10 may be, for example, textured to afford these surfaces with readily discerned sensible characteristics, such as visual or tactile characteristics, or with both. Corresponding materials may be temporarily applied to tooth surfaces so that reference marks match the file holder as this relates to sensible characteristics. It should be understood that where color coding is employed, the colors selected may be chosen to avoid any two or more colors that may appear the same or similar to a person whose visual color perception is impaired, an example being red and green, and which is readily distinguishable from the color of the tooth.

The file holder need not be limited to assuming the form of gauge 10. A file holder provided with color coding may be any device having a member which receives, sets length of, and retains files in a manner assuring visual or even tactile organization of files so that hasty retrieval of a file of a desired group of files is readily confirmed by visual or tactile feedback. The file holder could be, for example, a tray partitioned into several receptacles, provided the tray had surfaces arranged for ready recognition of files grouped according to their associated root canals. The file holder could comprise, in another example, one or more walls corresponding to retaining barrier 30, the walls having slots or other openings for receiving files. In still another example, the file retainer could comprise a body bearing a plurality of vertical, elongated holes. The precise nature of the file retainer is unimportant, provided that it can hold files in a manner making them accessible in readily discernible groups to a dental practitioner, and provides sensible marking enabling discrimination among the various groups of files.

The present invention is susceptible to variations which may be introduced thereto without departing from the inventive concept. Elements set forth in the singular may be replaced by plural elements to the same effect. Any of the variations of alternative embodiments may be combined as desired.

It is to be understood that the present invention is not limited to the embodiments described above, but encompasses any and all embodiments within the scope of the following claims.

I claim:

1. A method of sensibly correlating endodontic files to their respective root canals of a tooth, comprising the steps of:
placing a plurality of reference marks each having a discernible sensible characteristic different from those of other reference marks on a tooth undergoing a root canal procedure;
preparing plural endodontic files for reaming the root canals of the tooth undergoing the root canal procedure;
providing a holder for endodontic files having at least one receptacle capable of receiving and retaining a plurality of endodontic files and provided with a plurality of discernible sensible characteristics corresponding to those placed on the tooth;
placing all endodontic files in the holder such that
each endodontic file is grouped together with other endodontic files which are intended to be utilized with one particular root canal,
the groups of endodontic files associated with each root canal are separated from groups of endodontic files associated with other root canals, and
each group of endodontic files is sensibly correlated with one of the plurality of discernible sensible characteristics.

2. The method according to claim 1, wherein
said step of placing a plurality of reference marks on a tooth undergoing a root canal procedure comprises the further step of placing a plurality of hues on the tooth; and
said step of providing a holder for endodontic files comprises the further step of providing a plurality of hues on the holder, corresponding to the hues placed on the tooth.

3. A holder for organizing endodontic files for use in a root canal procedure in readily discernible and accessible groups, wherein each group of endodontic files is intended for use with one root canal, comprising a file retaining member disposed to hold endodontic files in a manner making the endodontic files accessible in readily discernible groups of endodontic files to a dental practitioner, and sensible marking disposed upon said file retaining member, said sensible marking disposed to enable discrimination among the various groups of endodontic files.

4. The holder according to claim 3, wherein said file retaining member is part of a gauge for selectively positioning stops along the shaft of endodontic files, comprising:
a base having formed therein a plurality of tracks each having a proximal end and a distal end, a floor disposed on one side of all of said tracks, and a retaining barrier disposed proximate said proximal end of said tracks, wherein
said retaining barrier has a plurality of openings each dimensioned and configured to receive therein an endodontic file, wherein all endodontic files disposed within said openings of said retaining barrier are aligned in coplanar relation to one another; and
a plurality of slides which are dimensioned and configured to be independently slidably disposed and securable within said tracks, wherein each one of said slides has an end surface disposed to face said retaining barrier,
wherein said retaining barrier is disposed to cause a stop placed in encircling relation on the shaft of an endodontic file to slide along the shaft when the shaft is advanced through a said opening of said retaining barrier, and
wherein said tracks are arranged to display endodontic files such that the endodontic files are longitudinally exposed to view from a common direction.

5. The gauge according to claim 4, wherein each one of said tracks is dimensioned and configured to guide and constrain its associated said slide to move only longitudinally within said track.

6. The gauge according to claim 4, wherein each said slide has a proximal end bearing a stepped surface and an opposed distal end, said stepped surface is disposed to occupy one said track and to move selectively towards and away from said proximal end of said track when said slide traverses said track, and said stepped surface has a plurality of flat steps each of which is spaced apart from said distal end by a distance interval different from that of every other said flat step.

7. The gauge according to claim 6, wherein said retaining barrier has openings formed at each track, the number of which said openings corresponding to the number of said steps of each said slide.

8. The gauge according to claim 4, wherein said tracks are parallel to and disposed in coplanar relation to one another, and each said track has height, width of magnitude greater than that of said height, and length of magnitude greater than that of said width.

9. The gauge according to claim 4, wherein all of said tracks face upwardly when said base is oriented horizontally and when said floor faces downwardly, thereby exposing all endodontic file settings to simultaneous view.
